(19) United States
(12) Patent Application Publication
(10) Pub. No.: US 2025/0229818 A1
(43) Pub. Date: Jul. 17, 2025

(54) TROLLEY CHASSIS SYSTEM

(71) Applicant: NASER KHAN, LOS ANGELES, CA (US)

(72) Inventor: NASER KHAN, LOS ANGELES, CA (US)

(21) Appl. No.: 18/411,120

(22) Filed: Jan. 12, 2024

(51) Int. Cl. B62B 3/02; B62B 3/14

(52) U.S. Cl. CPC B62B 3/02; B62B 3/1404

(57) ABSTRACT

A lightweight four-wheeled trolley chassis system for use in transport of daily mail and packages. Four rectangular blocks are placed on top of four wheel mounting plates to attach wheels from under to trolley chassis. Rectangular blocks help prevent breakages within wheels by absorbing daily shocks that occur as trolley travels onto different surfaces such as concrete, asphalt, brick, carpet, and tile. Trolley securely holds onto United States Postal Service (USPS) daily mail containers on top with no risk of sliding or falling during travel. Trolley handle rotates to a vertical position during operating condition and folds horizontally onto chassis for storage in non operating condition. A wooden support bar is attached on one end of chassis that spins and locks to allow vertical storage of trolley in small spaces. The trolley chassis uses no complex machined parts allowing workers to replace or tighten screws using standard tools.

### BACKGROUND OF INVENTION

### Field of Invention

The present invention relates to a trolley. More particularly, to a portable trolley chassis system for use in transportation and distribution of mail and packages by postal and parcel service providers on their daily routes.

### Description of Prior Art

A variety of wheeled trolleys have been suggested to help workers in different industries to perform their daily tasks. U.S. Pat. No. 9,694,839 describes a medical trolley cart to store various medical equipments used by doctors during surgical procedures in an operating room. Another example, U.S. Pat. No. 7,398,978 describes a foldable trolley for use in transportation and storage of items needed in operating a beauty salon. Similarly, U.S. Pat. No. 9,446,777 suggests a vertical trolley to support and transport standard propane gas buckets. Another example, US. Pat. No. 2022/0119056 suggests a multifunction garden cart to carry different kinds of loads from builders sack, hanged lads, or can be adapted to move grass, and flowers.

Another type of trolley cart suggested has horizontal shelves one on top of another to store items and save floor space in warehouses and grocery stores. The U.S. Pat. No. 3,782,746 suggests a self-supporting cart which can be nested on top of an identical cart configuration for purpose of carrying more items while saving floor space in warehouses and food distribution. Another example, U.S. Pat. No. 4,159,831 suggests a cart to transport stacked products from a production facility to place as a display cart at a retail outlet. Similarly, U.S. Pat. No. 3,891,228 suggests a multiple shelve cart with back support to transport milk containers from a dairy processing plant to supermarkets for distribution or direct placement as a display cart. Another example, U.S. Pat. No. 11,730,263 suggests a cart to store and distribute food trays placed horizontally with separate storage for hot and cold food. Similarly, U.S. Pat. No. 5,947,494 suggests a cart to store and distribute food trays in confined spaces such as aisles of passenger aircraft and railway diners. In addition, U.S. Pat. No. 6,213,494 suggest a serving cart for use in moving food and drinks in a restaurant that can be easily folded to store in a small space.

A number of trolley carts are suggested with horizontal racks for use in re-stocking merchandise. For example, U.S. Pat. No. 8,770,600 describes a light-weight polymeric retail cart that assembles and disassembles without need for tools useful to restock merchandise at retail-stores. Another example, U.S. Pat. No. 3,902,603 suggests a cart with horizontal racks to support individual trays with sorted mail, where each tray can be pulled outward to access mail and kept locked using a retainer bar. Similarly, U.S. Pat. No. 8,931,420 suggests a stocking cart that can be coupled to another similar cart and moved or lifted together by a standard fork lift, allowing ease in transporting lots of items from a warehouse using a truck to a retail store.

There are certain trolley carts used by consumers on daily basis or for recreational use. The U.S. Pat. No. 7,396,025 describes an improved shopping cart with nesting arrangement and fixed child seat in the rear. Similarly, U.S. Pat. No. 5,294,158 describes a collapsible handcart that can easily climb stairs allowing customers to lift grocery items within a building without an elevator. Another example, U.S. Pat. No. 4,316,615 suggests a recreational outdoor beach cart for carrying supplies to and from a beach picnic. Similarly, U.S. Pat. No. 4,362,308 describes a portable chair and cart combination to help carry items such as blankets, coolers, and foldable chairs from an automobile to the picnic area. In addition, U.S. Pat. No. 10,435,055 describes a collapsible cart when unfolded supports a fabric on top to store variety of outdoor picnic items. Similarly, U.S. Pat. No. 11,285,983 suggested a foldable cart when unfolded has the ability to expand storage capacity by supporting additional baskets behind or below the main cart.

There are certain trolley carts suggested only for use in one specialized task. Example, U.S. Pat. No. 11,718,334 suggests a cart to carry vehicle doors and vehicle roofs in automobile manufacturing facility. Another example, US. Pat. No. 2023/0211818 describes a cart and rack assembly to safely transport planar material such as laminate, wood, sheet metal, tile, and glass. Similarly, U.S. Pat. No. 11,292,293 suggests a trolley for transportation of heavy wheels for the maintenance of trailers and trucks. The U.S. Pat. No. 5,199,729 mentions a rigid cart for moving large baggage and cargo at the airport. Similarly, the U.S. Pat. No. 4,066,022 suggests a metal welded cart with an opening on top for use in transportation of linen from hospitals to laundries.

Another type of cart commonly used in transporting objects is the “Hand Truck” or two wheeled transport dollies comprising a toe plate which is fixed in perpendicular orientation to a support frame with a pair of wheels located on the ends. The operator places the object to carry onto the toe plate, and grasps the support frame to rotate and lift the toe plate and the wheels get in motion to allow the operator to move the object. Example, U.S. Pat. No. 3,827,707 suggests a hand truck to transport luggage for a short distance. Another example, U.S. Pat. No. 6,237,925 describes a hand truck that has a ground engaging flipper which allows ease in lifting heavy items. Similarly, U.S. Pat. No. 6,971,654 suggests a hand truck with toe plate capable of being elevated to allow ease in loading and unloading items. In addition, U.S. Pat. No. 7,104,555 suggests a hand truck with multiple shelves attached to the support frame one on top of the other to carry large number of items together.

Most prior art trolley carts and hand trucks are made with heavy-grade metal, or include lots of complex machined parts making it difficult to assemble and use on a daily basis. The trolley carts used in package and mail distribution undergo constant shocks due to changing surfaces such as concrete, asphalt, brick, carpet, and tile, causing breakages in the wheel joints and making the trolley of no use to the worker. Furthermore, any breakages in the metal frame requires a machinist to weld the complex metal parts causing delays in performing daily tasks, or forces a worker to buy a new trolley to perform their daily work. In addition, loosening of a screw or breakages in the metal frame joints during work hours cannot be easily fixed, and can result in physical harm to workers as they have to individually carry and deliver each package.

### SUMMARY OF INVENTION

It is an object of the present invention to provide a lightweight four-wheeled trolley chassis system for daily use in transport and distribution of mail and packages by postal service and parcel service workers.

It is another object of the invention to provide a trolley chassis with four rectangular block units placed under at the corners that securely attach on top of a standard mounting plate of a wheel. The rectangular block units have a predefined dimension in length, width, and thickness with four holes on top that align with the four holes present on a standard mounting plate of a wheel. The rectangular block units provide two major functions. First, to securely attach the wheels onto the trolley chassis using standard screws. Second, to absorb daily shocks that occur when the trolley chassis travels onto different surfaces such as concrete, asphalt, brick, wood, carpet, and tile, in turn preventing breakages and reducing damages to the wheels.

A still further object of the present invention is to provide a trolley chassis with a handle assembly having a S-hook lock mechanism system to lock the handle assembly onto the front of the trolley during operating condition, and upon release the handle assembly can be locked laying flat onto the chassis allowing for secure horizontal storage of the trolley chassis.

Another object of the present invention is to provide a trolley chassis system with a support bar stand attached to one end of the chassis that spins and locks to allow storage of the trolley in vertical position on the floor by a wall in a work facility or within a work truck.

A further object of present invention is to provide a trolley chassis system which, when assembled into operating condition securely holds onto United States Postal Service (USPS) daily mail containers on top without any risk of falling or sliding off the trolley chassis as the worker pulls the trolley to distribute mail and packages on their daily routes.

A still further object of the present invention is to provide a light-weight trolley chassis system that allows postal and parcel service workers to easily lift and store within a work truck.

Another object of the present invention is to provide a trolley chassis system made of industry standard metal, wood, screws, nuts, and bolts with no complex machined metal parts allowing workers to easily fix any problems faced during work hours such as tightening or replacing screws, nuts, and bolts using a screwdriver and parts available at any hardware store.

These and other objects of the present invention are fulfilled by constructing a wooden trolley chassis system which includes two longer wooden bars of same length and square cross section placed horizontally parallel to each other at a set distance apart. Flat rectangular wooden planks are attached from under to ends of the longer wooden bars using a pair of wood screws. The flat rectangular wooden planks are used to store USPS daily mail containers and packages. Two vertical wooden planks are attached one in the front and one in the back to the ends of the longer wooden bars using L-shaped bracket and small wood screws. A rectangular wood-block having four holes is placed on top of a standard mounting plate of a wheel having similar four holes on top. The holes of the rectangular wood-block and standard mounting plate align with each other to allow attachment of the wheels from under to the four corners of the trolley chassis using wood screws. A wooden support bar stand attached to one end of the longer wooden bar can support trolley chassis in vertical position on the floor to allow vertical storage of trolley chassis by a walls within a work facility or in a work truck.

A handle assembly is attached behind the front vertical wooden plank consisting of—two small wooden bars placed vertically parallel at a set distance apart. Two longer vertical wooden bars are attached to the small wooden bars from inside using wood screws. A middle support bar is attached in between the two longer vertical wooden bars to keep them always in parallel and a lower support bar is attached under for stability. A circular wooden handle is attached on top in between the two longer vertical wooden bars. S-shaped hook is attached on front surface of each small wooden bar. When the S-shaped hooks enter S-shaped holes present on the front vertical wooden plank, the handle assembly is fixed in vertical position for operating condition. An operator by using the circular wooden handle can pull the trolley in any desired location. When the S-shaped hooks are released and then entered into S-shaped holes present on the two longer wooden bars the handle assembly is set in flat position for horizontal storage condition.

### BRIEF DESCRIPTION OF THE DRAWINGS

FIG. 1 is a front perspective view of the wooden trolley chassis system in accordance with a preferred embodiment of the present invention.

FIG. 2 is a top view of the wooden trolley chassis system with the handle assembly in vertical operating condition in accordance with a preferred embodiment of the present invention.

FIG. 3 is a side view of the wooden trolley chassis system with the handle assembly in vertical operating condition in accordance with a preferred embodiment of the present invention.

FIG. 4 is a front view of the wooden trolley chassis system with the handle assembly in vertical operating condition in accordance with a preferred embodiment of the present invention.

FIG. 5 is an enlarged sectional view of the trolley chassis system taken on line 5-5 of FIG. 3, showing handle assembly in vertical operating condition using S-hook lock mechanism system.

FIG. 6 is a front perspective view of the handle assembly of the wooden trolley chassis system taken on line 6-6 of FIG. 3.

FIG. 7 is a perspective exploded view of the handle assembly taken on line 7-7 of FIG. 6 in accordance with a preferred embodiment of the present invention.

FIG. 8 is a perspective view of the wooden trolley chassis system in horizontal storage position.

FIG. 9 is an enlarged sectional view of the trolley chassis system taken on line 9-9 of FIG. 8, showing S-hook lock mechanism system restricting rotational movement of handle assembly.

FIG. 10 is a bottom view of the wooden trolley chassis system with handle assembly in horizontal storage position in accordance with a preferred embodiment of the present invention.

FIG. 11 is a perspective exploded view of the section taken on line 11-11 of FIG. 10, showing the back-side wood-block wheel assembly system attached under the trolley chassis system.

FIG. 12 is a perspective exploded view of the section taken on line 12-12 of FIG. 4, showing the front-side wood-block wheel assembly system attached under the trolley chassis system.

FIG. 13 is a perspective view of wooden trolley chassis system in vertical storage position using wooden support bar stand in accordance with a preferred embodiment of the present invention.

FIG. 14 is a top view of the wooden trolley chassis system in vertical storage position using the wooden support bar stand in accordance with a preferred embodiment of the present invention.

FIG. 15 is a front perspective view of the wooden trolley chassis system in operating condition carrying USPS daily mail containers on top according to embodiments of the present invention.

### DETAILED DESCRIPTION OF THE DRAWINGS

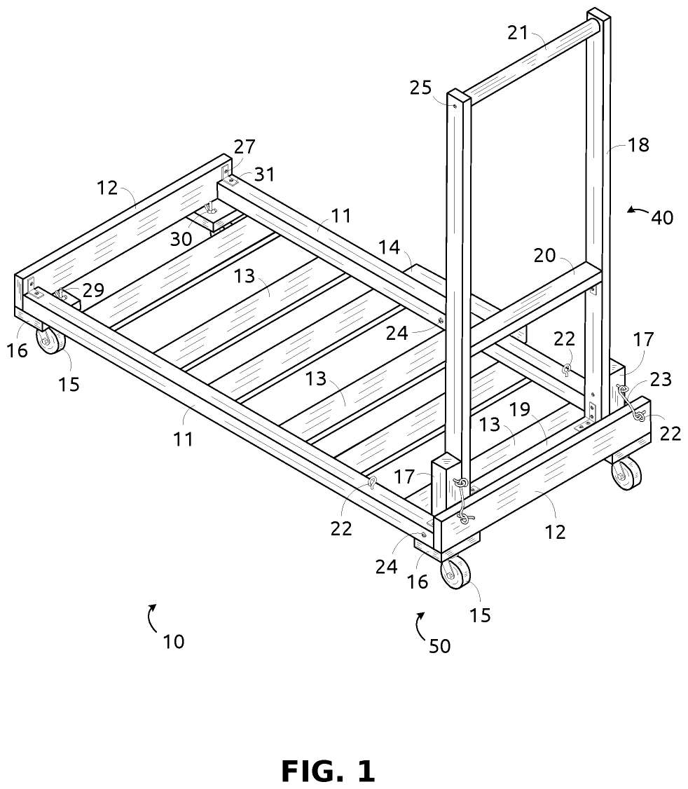

The drawings illustrate a wooden trolley chassis system 10 according to an exemplary embodiment of the present invention. As best illustrated in FIG. 1, the wooden trolley chassis system 10 comprises of two longer wooden bars 11 of equal length and a square cross section placed horizontally parallel to each other at a set distance apart. A set number of flat rectangular wooden planks 13 are placed perpendicular under the longer wooden bars 11 and attached at the ends using a pair of wood screws. The flat rectangular wooden planks 13 hold the daily mail and packages on top. Two vertical wooden planks 12 are attached one in the front and one in the back to the ends of the longer wooden bars 11 using a small L-Shaped bracket 31 and two small wood screws 27. Each vertical wooden plank 12 is rectangular in shape and has a length equal to the distance between the outer ends of the longer wooden bars 11. A wooden support bar stand 14 is attached to one of the longer wooden bar 11 using a long machine screw 24. The wooden support bar stand 14 is only used when storing the wooden trolley chassis system 10 in vertical position and remains parallel to the longer wooden bar 11 during operating condition.

A handle assembly 40 is attached in between the longer wooden bars 11 behind the front vertical wooden plank 12 using two long machine screws 24. Each long machine screw 24 pass through a hole on the outer surface of the longer wooden bar 11 to enter a hole at the bottom of the small wooden bar 17 of the handle assembly 40. The holes have space to allow rotational movement of the long machine screw 24 in turn allowing the handle assembly 40 to rotate from a vertical standing position to a horizontal flat position. The handle assembly 40 is shown in a vertical standing position using S-hook lock mechanism system as S-shaped hooks 23 on the small wooden bars 17 are inserted into S-shaped holes 22 on front vertical wooden plank 12, the S-shaped holes 22 are fixed to restrict movement of the S-shaped hooks 23 and maintain the handle assembly 40 in vertical standing position during operating condition. The small wooden bar 17 is attached in parallel to a longer vertical wooden bar 18. The two longer vertical wooden bars 18 are attached on top to a circular wooden handle 21 using two long wooden screws 25. A middle support bar 20 is attached in between to ensure the longer vertical wooden bars 18 stay at a fixed distance and in parallel to each other. A lower support bar 19 is attached to the bottom of the longer vertical wooden bars 18 that helps to provide stability to the lower portion of the handle assembly 40. Two more S-shaped holes 22 are placed, one on each longer wooden bar 11 for use in storing the wooden trolley chassis system 10 in horizontal position.

Four wood-block wheel assembly systems 50 are attached from under at the corners of the wooden trolley chassis system 10. Each wood-block wheel assembly system 50 consist of—a rectangular wood-block 16 having four holes, and a wheel 15 with a standard wheel mounting plate having four holes. The rectangular wood-block 16 is placed on top of the standard wheel mounting plate of the wheel 15 allowing the holes to align. Three big wood screws pass from under through the holes of the standard wheel mounting plate and rectangular wood-block 16 to attach the wheel 15 to both vertical wooden plank 12 and the longer wooden bar 11. A single machine screw 29 passes through the inner hole of rectangular wood-block 16 to fasten on top to a wing-nut 30. The rectangular wood-block 16 has two man functions. First, securely attach the wheel 15 onto the wooden trolley chassis system 10. Second, to absorb daily shocks that occur as the wooden trolley chassis system 10 travels onto different surfaces such as concrete, asphalt, brick, wood, carpet, and tile in turn preventing breakages and damage to the wheels 15.

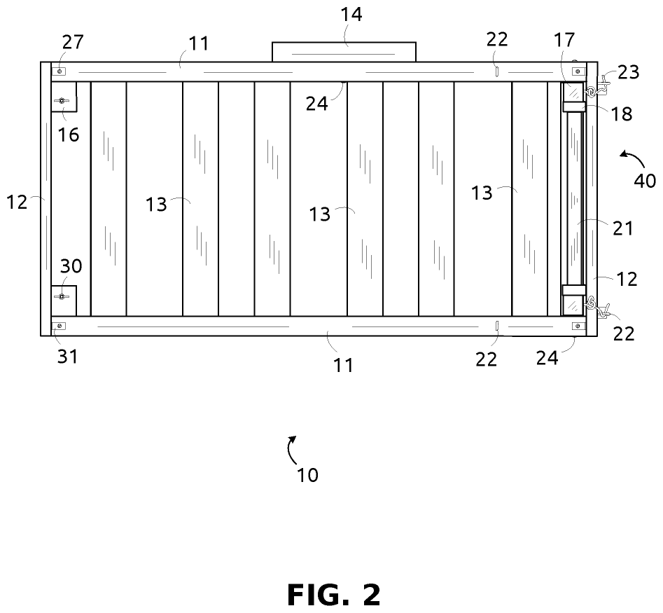

FIG. 2 illustrates top view of the wooden trolley chassis system 10 showing the vertical wooden planks 12 attached on either ends to the longer wooden bars 11 using small L-Shaped bracket 31 and small wood screws 27. Flat rectangular wooden planks 13 are attached under to the ends of the longer wooden bars 11. The handle assembly 40 is placed behind front vertical wooden plank 12 and attached onto the ends of the longer wooden bars 11 using a long machine screw 24 that passes through the small wooden bar 17. The handle assembly 40 is set in vertical position for operating condition using S-hook lock mechanism system as S-shaped hooks 23 on small wooden bars 17 enter S-shaped holes 22 on front vertical wooden plank 12, the S-shaped holes 22 stay fixed to restrict movement of the S-shaped hooks 23. The small wooden bars 17 are attached to two longer vertical wooden bars 18 that are attached on top to a circular wooden handle 21. A wooden support bar stand 14 is attached to one longer wooden bar 11 using a long machine screw 24. On the back-side, the wing-nut 30 is seen attached on top to a machine screw that passes through from under the inner hole of the rectangular wood-block 16.

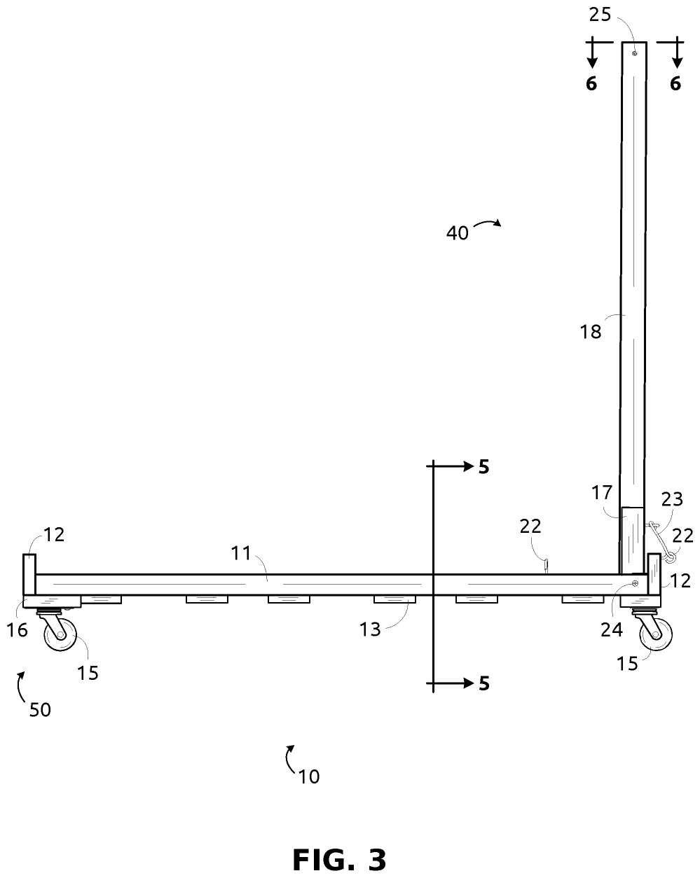

FIG. 3 illustrates the side-view of wooden trolley chassis system 10 showing the handle assembly 40 attached in front using a long machine screw 24 that enters from the outer surface of longer wooden bar 11 to pass through a hole at the bottom of the small wooden bar 17. The longer vertical wooden bar 18 is attached in parallel next to the small wooden bar 17. Two long wooden screws 25 are used to attach a circular handle in between the longer vertical wooden bars 18. S-hook lock mechanism system working is seen as S-shaped hooks 23 of the small wooden bars 17 enter S-shaped holes 22 on front vertical wooden plank 12, S-shaped holes 22 stay fixed to restrict the movement of S-shaped hooks 23 and maintain the handle assembly 40 in vertical position during operating condition. The wood-block wheel assembly system 50 is seen in front and back with rectangular wood-block 16 and wheel 15 attached under to both the vertical wooden planks 12 and the longer wooden bar 11. Flat rectangular wooden planks 13 are attached from under to the longer wooden bars 11 with gaps in between that helps to reduce the overall weight of the wooden trolley chassis system 10. A pair of S-shaped hole 22 are attached one on each longer wooden bar 11. The workings of the wood-block wheel assembly system 50 and the S-hook lock mechanism system allows the operator to use the handle assembly 40 to control and direct the movement of the wooden trolley chassis system 10.

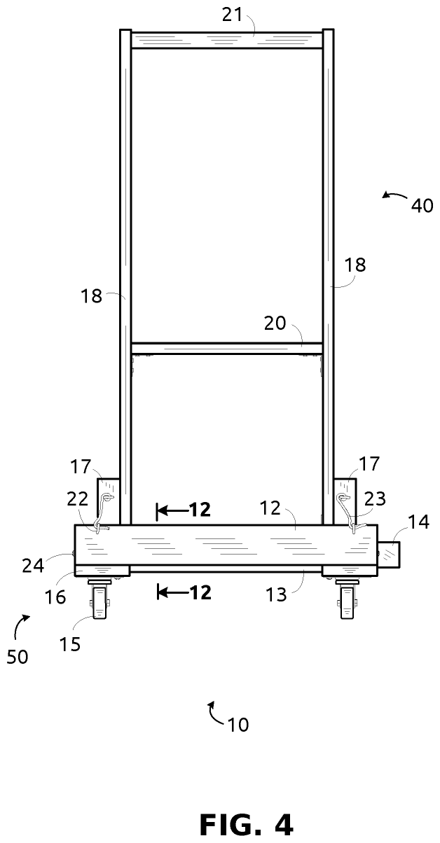

FIG. 4 shows the front-view of the wooden trolley chassis system 10 with the handle assembly 40 in vertical operating condition using S-hook lock mechanism system as S-shaped hooks 23 of small wooden bar 17 are inserted into S-shaped holes 22 of front vertical wooden plank 12. A longer vertical wooden bar 18 are attached in parallel from inside to small wooden bar 17. A middle support bar 20 is attached in between the two longer vertical wooden bars 18 to provide support. A circular wooden handle 21 is attached on top in between the longer vertical wooden bars 18. Front wood-block wheel assembly system 50 is seen with rectangular wood-block 16 and wheel 15 attachment to front vertical wooden plank 12. A wooden support bar stand 14 is attached to one end of the wooden trolley chassis system 10. As the operator pulls the circular wooden handle 21, the small wooden bars 17 and the longer vertical wooden bars 18 lean forward towards the front vertical wooden plank 12 and the wheels 15 get into motion allowing movement of the wooden trolley chassis system 10 forward while S-hook lock mechanism system helps keep handle assembly 40 in vertical position for operating condition.

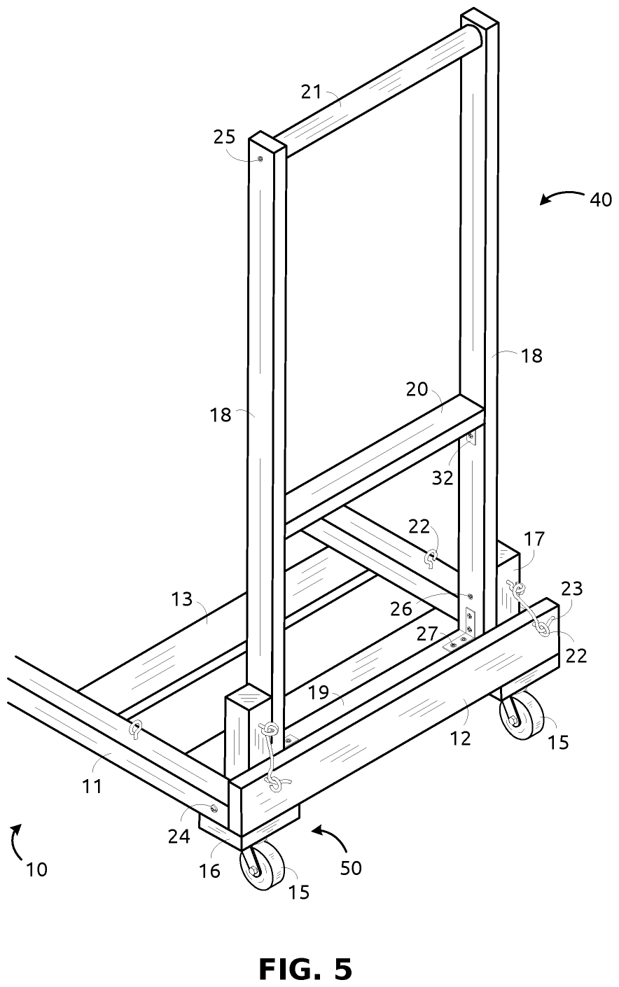

FIG. 5 is an enlarged sectional view of the wooden trolley chassis system 10 taken on line 5-5 of FIG. 3, showing handle assembly 40 in vertical operating condition. S-hook lock mechanism system working is seen as S-shaped hooks 23 are inserted into S-shaped holes 22 of the front vertical wooden plank 12, the S-shaped holes 22 stay fixed to restrict movement of the S-shaped hooks 23 keeping the small wooden bars 17 in vertical position. Each small wooden bar 17 is attached to a longer vertical wooden bar 18 using a mid-size wood screw 26, to make sure longer vertical wooden bars 18 also stays in vertical position. A lower support bar 19 and a middle support bar 20 is attached in between the longer vertical wooden bars 18 using two large L-brackets 32 and small wood screws 27 to provide support to handle assembly 40. A circular wooden handle 21 is attached using long wooden screws 25 on top in between longer vertical wooden bars 18. The front wood-block wheel assembly system 50 is seen with the rectangular wood-block 16 and wheel 15 attachment to both front vertical wooden plank 12 and the longer wooden bar 11. The connection of the handle assembly 40 and the wood-block wheel assembly system 50 to the front vertical wooden plank 12 allows the operator to use the circular wooden handle 21 to control the directional movement of the wooden trolley chassis system 10.

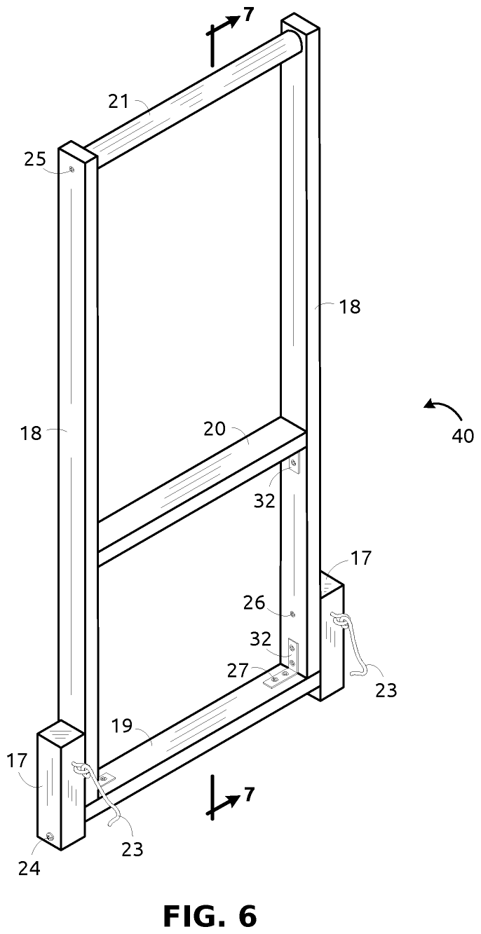

FIG. 6 shows the components of the handle assembly 40 of the wooden trolley chassis system 10. On either end, a small wooden bar 17 is placed in parallel to each other and attached to a longer vertical wooden bar 18 using a mid-size wood screw 26. A lower support bar 19 is attached under the longer vertical wooden bar 18 using two large L-brackets 32 and small wood screws 27. A middle support bar 20 is attached using two large L-brackets 32 and small wood screws 27 at the ends to the longer vertical wooden bars 18 to keep them in parallel. A circular wooden handle 21 is attached on top in between the longer vertical wooden bars 18 using long wooden screws 25. A hole on the side of small wooden bars 17 allows a long machine screw 24 to pass through to help attach the handle assembly 40 to the longer wooden bar 11. A S-shaped hook 23 is placed on the front of each small wooden bar 17 for use in S-hook lock mechanism system. The connection between the small wooden bars 17, the longer vertical wooden bars 18, middle support bar 20, and lower support bar 19 allows uniform movement of all components. An operator using the circular wooden handle 21 can control both the rotational movement of handle assembly 40 and the directional movement of the wooden trolley chassis system 10.

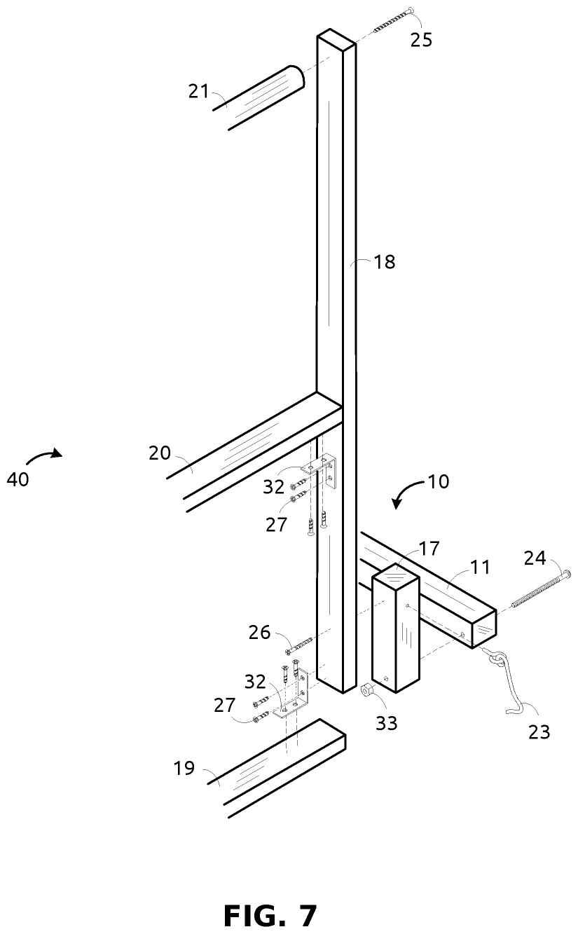

FIG. 7 is the exploded view taken on line 7-7 of FIG. 6 showing internal attachment of components that make up the handle assembly 40. On each end, the longer vertical wooden bar 18 connects with all the component of the handle assembly 40. The small wooden bar 17 is attached to the longer vertical wooden bar 18 using a mid-size wood screw 26. At the bottom, a lower support bar 19 is attached to the ends using large L-bracket 32 and small wood screws 27. The lower support bar 19 provides stability to lower section of handle assembly 40. Similarly, a middle support bar 20 is attached using a large L-bracket 32 and small wood screws 27 to force the longer vertical wooden bars 18 to stay in parallel. A circular wooden handle 21 is attached on top in between the longer vertical wooden bars 18 using two long wooden screws 25.

FIG. 7 also shows how the handle assembly 40 is attached onto the wooden trolley chassis system 10. From bottom right, a long machine screw 24 enters a hole present on the outer surface of longer wooden bar 11 to then pass through a hole on the small wooden bar 17 to finally attach onto a fixed nut 33. The fixed nut 33 is located below the lower support bar 19 attachment to the longer vertical wooden bar 18. The holes on the small wooden bar 17 and the longer wooden bar 11 have space to allow rotational movement of the long machine screw 24, thus allowing rotational movement of the handle assembly 40. The fixed nut 33 has two major functions. First, to firmly hold onto the tip of the long machine screw 24, thus prevent it from sliding out of the holes, and ensuring secure attachment of handle assembly 40 onto the longer wooden bar 11. Second, to allow the long machine screw 24 to rotate within the holes of small wooden bar 17 and longer wooden bar 11 ensuring rotational movement of handle assembly 40.

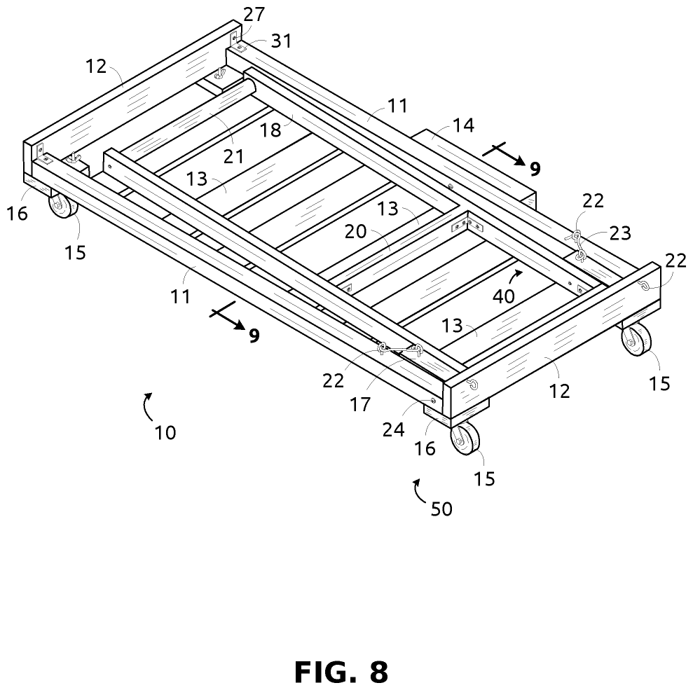

FIG. 8 shows the wooden trolley chassis system 10 in horizontal storage position. First, the operator releases handle assembly 40 from vertical operating condition as shown in FIG. 4 by detaching the S-shaped hooks 23 on small wooden bars 17 from S-shaped holes 22 on front vertical wooden plank 12. Next, the operator rotates handle assembly 40 using circular wooden handle 21 until the longer vertical wooden bars 18 and middle support bar 20 rest on top of flat rectangular wooden planks 13. Finally, S-shaped hook 23 on small wooden bar 17 are inserted into S-shaped holes 22 on each longer wooden bar 11 to restrict rotational movement of handle assembly 40 allowing secure storage of wooden trolley chassis system 10 in horizontal position.

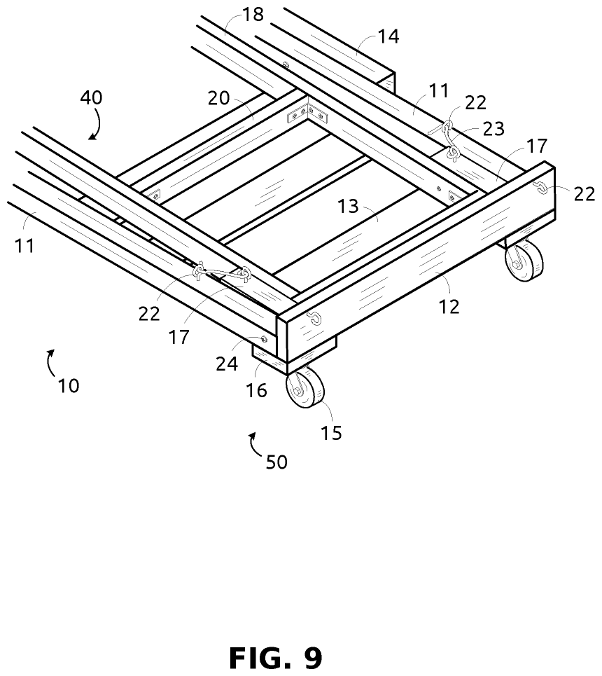

FIG. 9 is an enlarged sectional view of the wooden trolley chassis system 10 taken on line 9-9 of FIG. 8 showing S-hook lock mechanism system restrict the rotational movement of the handle assembly 40. As the handle assembly 40 moves upward, the small wooden bars 17 move up pulling both the S-shaped hooks 23 and longer vertical wooden bars 18 with it. Since, the S-shaped holes 22 on longer wooden bars 11 are fixed, the movement of S-shaped hooks 23 is held back restricting rotational movement of handle assembly 40. The handle assembly 40 falls back to make sure the longer vertical wooden bars 18 and middle support bar 20 rests back on top of the flat rectangular wooden planks 13, thus ensuring secure storage of the wooden trolley chassis system 10 in horizontal position.

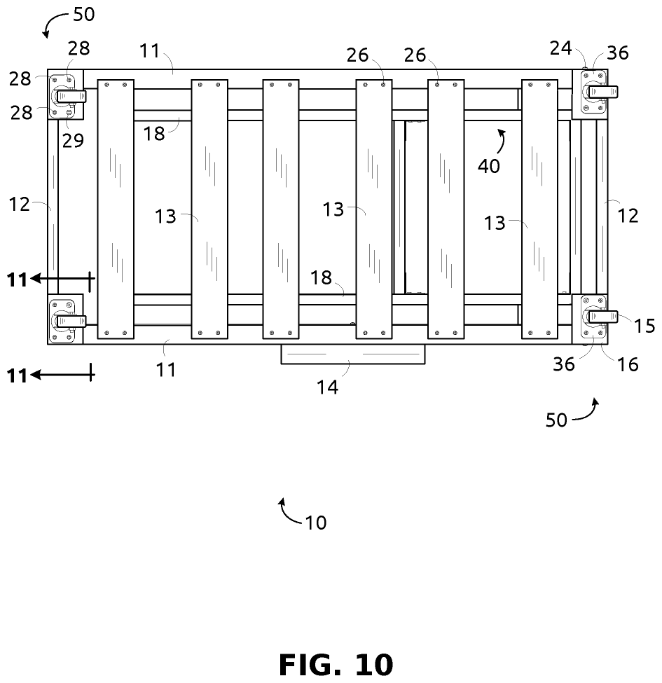

FIG. 10 shows the bottom view of the wooden trolley chassis system 10 with handle assembly 40 in horizontal storage position. The flat rectangular wooden planks 13 are attached from under to the ends of longer wooden bars 11 using two mid-sized wood screws 26. There are gaps between the flat rectangular wooden planks 13 to help reduce the overall weight of the trolley chassis. A wood-block wheel assembly system 50 is attached from under at each corner of the wooden trolley chassis system 10 that consist of a rectangular wood-block 16 placed on top of a standard wheel mounting plate 36 of a wheel 15. The rectangular wood-block 16 and standard wheel mounting plate 36 have four holes that align with each other. Three big wood screws 28 pass through the holes of rectangular wood-block 16 and standard wheel mounting plate 36 to attach the wheels 15 to both the vertical wooden plank 12 and longer wooden bar 11. A single machine screw 29 passes through the inner hole to fasten on top to a wing-nut.

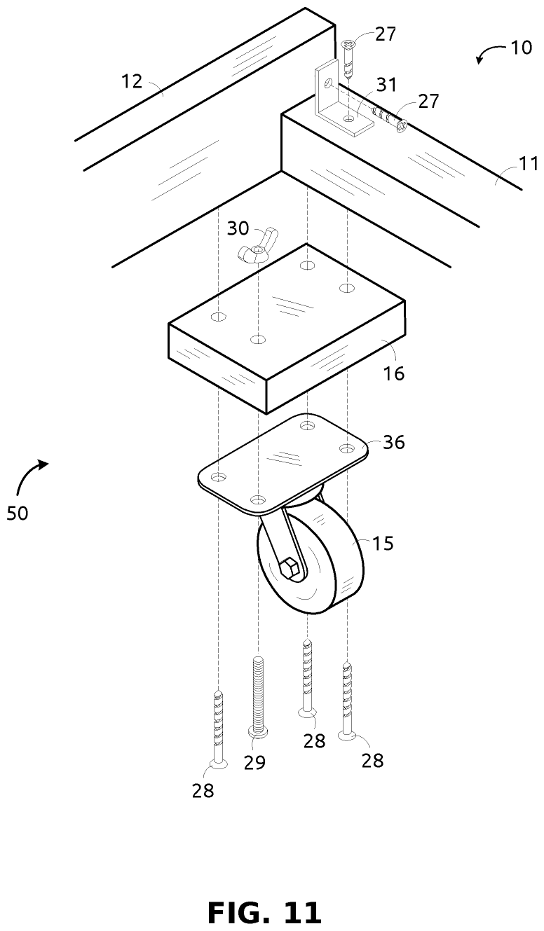

FIG. 11 is an exploded view of section taken on line 11-11 of the FIG. 10 showing the components and attachment of wood-block wheel assembly system 50 on the back-side of the wooden trolley chassis system 10. A rectangular wood-block 16 is placed on top of a standard mounting plate 36 of a wheel 15. The rectangular wood-block 16 has four holes at set measurements that align with the four holes present on top a standard wheel mounting plate 36 of a wheel 15. Three big wood screws 28 and one machine screw 29 passes through the holes from under the standard mounting plate 36 of a wheel 15 to enter the holes of the rectangular wood-block 16. Two of the three big wood screws 28 enters the back vertical wooden plank 12, and the third enters the longer wooden bar 11 to securely attach the wheel 15 and rectangular wood-block 16 onto the wooden trolley chassis system 10. A single machine screw 29 passes through the inner hole to fasten on top to a wing-nut 30. The figure also shows how the vertical wooden plank 12 attaches to the longer wooden bar 11 using a small L-Shaped bracket 31 and two small wood screws 27.

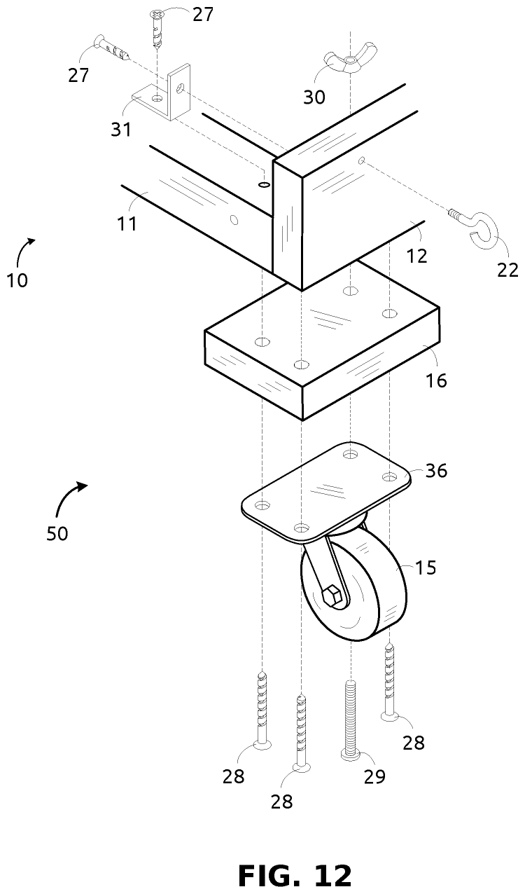

FIG. 12 is an exploded view of the section taken on line 12-12 of FIG. 4 showing the components of wood-block wheel assembly system 50 on the front-side of the wooden trolley chassis system 10. A rectangular wood-block 16 with four holes is placed on top of a standard mounting plate 36 of a wheel 15 having four identical holes. Three big wood screws 28 and one machine screw 29 passes through the holes from under the standard mounting plate 36 of the wheel 15 to enter the holes of rectangular wood-block 16. The two big wood screws 28 enter the front vertical wooden plank 12, and the third enters longer wooden bar 11 to securely attach the wheel 15 and rectangular wood-block 16 to the wooden trolley chassis system 10. A single machine screw 29 is fastened on top to a wing-nut 30. FIG. 12 also shows the S-shaped hole 22 attachment to the front vertical wooden plank 12 and the connection of longer wooden bar 11 to front vertical wooden plank 12 using a small L-Shaped bracket 31 and small wood screws 27.

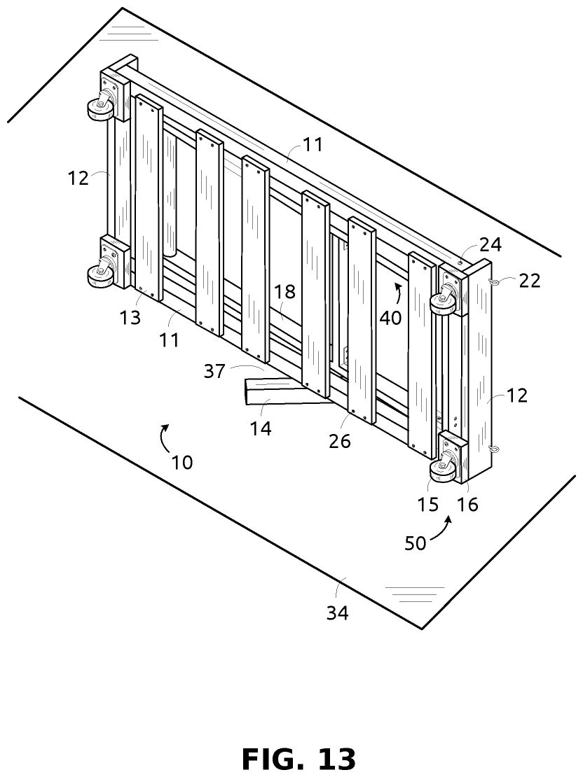

FIG. 13 shows the workings of wooden support bar stand 14 to place the wooden trolley chassis system 10 in vertical storage position. First, the operator places wooden trolley chassis system 10 in horizontal storage position as shown in FIG. 8. Next, the operator lifts the trolley chassis in vertical position holding the longer wooden bar 11 opposite the wooden support bar stand 14. Next, the operator rotates the wooden support bar stand 14 to a set angle 37. The set angle 37 is measured between the wooden support bar stand 14 and the longer wooden bar 11 moving towards the back vertical wooden plank 12. Once set angle 37 is an acute angle (under 90 degree), the wooden support bar stand 14 will support the wooden trolley chassis system 10 in vertical position onto the floor 34. Vertical storage position allows postal and parcel service workers to store the wooden trolley chassis system 10 inside a work truck by the edge of a wall leaving room to carry mail and packages on daily routes. In addition, vertical storage of wooden trolley chassis system 10 next to a wall prevents blockages of passage ways in a work facility.

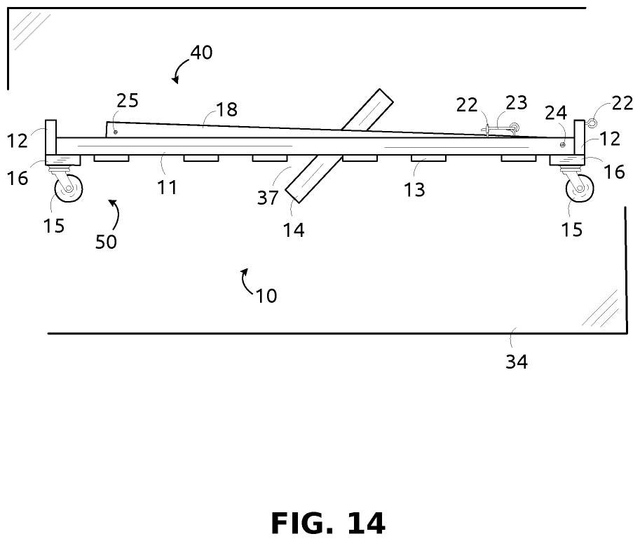

FIG. 14 shows the top view of the wooden trolley chassis system 10 in vertical storage position with wooden support bar stand 14 resting onto the floor 34. The wooden support bar stand 14 extends on both ends of longer wooden bar 11 to prevent the wooden trolley chassis system 10 from falling onto the floor 34. The wood-block wheel assembly system 50 on four corners are suspended in air and do not touch the floor 34 limiting movement of wooden trolley chassis system 10. The set angle 37 between wooden support bar stand 14 and longer wooden bar 11 is placed at an acute angle (under 90 degree) to ensure the wooden support bar stand 14 always holds the wooden trolley chassis system 10 in vertical storage position. The S-hook lock mechanism system working is seen as S-shaped hooks 23 of handle assembly 40 enter S-shaped holes 22 of longer wooden bars 11 restricting rotational movement of handle assembly 40 and thus allowing secure storage of wooden trolley chassis system 10 in vertical storage position.

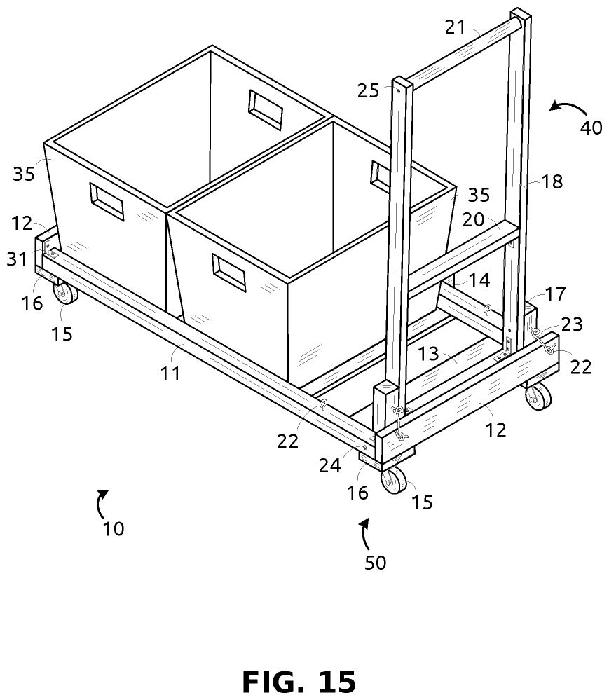

FIG. 15 illustrates the wooden trolley chassis system 10 in operating condition with the United State Postal Service (USPS) daily mail containers 35 on top for mail distribution. The handle assembly 40 is set in vertical operating condition by S-hook lock mechanism system as S-shaped hooks 23 on small wooden bars 17 enter S-shaped holes 22 of front vertical wooden plank 12. The USPS daily mail containers 35 rest on top of flat rectangular wooden planks 13 that are attached from below to the two longer wooden bars 11. The two longer wooden bars 11 and front and back vertical wooden planks 12 provide support on the ends to prevent the USPS daily mail containers 35 from falling or sliding off the wooden trolley chassis system 10.

FIG. 15 embodiment of the invention can hold two USPS daily mail containers 35. The ability to hold more than two USPS daily mail containers 35 can be implemented by increasing the length of the longer wooden bars 11 and attaching extra flat rectangular wooden planks 13 from below in between the longer wooden bars 11.

The foregoing provides both a general and specific description of preferred embodiment of the invention. It should be understood that various substitutions, variations, and modifications can be made by those skilled in the art without departing from the spirit or scope of the invention as further delineated in the following claims.

What is claimed is:

1. A trolley chassis system, comprising of:
a. a pair of longer bars of equal length and square cross section placed horizontally parallel to each other at a predefined distance,
b. a set number of flat rectangular planks of predefined dimensions attached from under to the ends of said longer bars,
c. a pair of vertical rectangular planks of predefined dimension attached to ends of said longer bars, one in front, and one in the back, wherein outer edges of said vertical rectangular planks align with outer edges of said longer bars,
d. whereby said flat rectangular planks hold packages and United State Postal Service (USPS) daily mail containers on top, wherein said longer bars and said vertical rectangular planks provide support on the ends to prevent packages and USPS daily mail containers from falling or sliding off when said trolley chassis system is in motion.

2. The trolley chassis system according to claim 1, further including a wheel assembly system attached under at each corner of said trolley chassis system, comprising of:
a. a wheel attached below a wheel mounting plate of rectangular shape with predefined length and width having four holes on top,
b. a rectangular block of predefined dimension in length, width, and thickness, wherein said rectangular block has four holes on top that align with the four holes present on said wheel mounting plate,
c. whereby said rectangular block is placed on top of said wheel mounting with the four holes align with each other,
d. three screws of set dimension pass from under through holes of said wheel mounting plate and said rectangular block to attach the wheel at the corner to both longer bar and vertical rectangular plank of said trolley chassis system,
e. a single machine screw of predefined dimension passes through the fourth hole of said wheel mounting plate and said rectangular block to attach on top to a wing nut, wherein said wing nut rests on top of said rectangular block,
f. whereby said rectangular block tightly holds onto said wheel mounting plate to absorb daily shocks that occur as said trolley chassis system travels onto different surfaces such as concrete, asphalt, brick, wood, carpet, and tile, in turn preventing breakages in said wheel mounting plate and said wheels.

3. The trolley chassis system according to claim 1, further including a handle assembly, comprising of:
a. a pair of small vertical bars of equal height and square cross section placed parallel to each other at a predefined distance apart,
b. a pair of longer vertical bars of equal height and rectangular cross section, wherein width of said longer vertical bar equals width of said small vertical bar, whereby each longer vertical bar is attached in parallel to the inside surface of said small vertical bar using a single screw,
c. a lower support bar of rectangular cross section attached horizontally from under to the ends of said longer vertical bars using L-brackets and small screws, wherein length of said lower support bar equals the predefined distance between the said small vertical bars,
d. a middle support bar of rectangular cross section attached in between said longer vertical bars using L-brackets and small screws at the ends, wherein length of middle support bar equals distance between the longer vertical bars,
e. whereby length of said middle support bar forces said longer vertical bars to stay in parallel at the predefined distance between said small vertical bars,
f. a circular handle attached on top in-between said longer vertical bars using a pair of long screws on the ends, wherein said long screw passes through the outer surface of said longer vertical bar to enter the center of circular handle, whereby circular handle stays fixed in between said longer vertical bars,
g. said longer vertical bars connect with all parts-small vertical bar, lower support bar, middle support bar, and circular handle, whereby creating a single unit handle assembly for use in said trolley chassis system,
h. whereby height of said longer vertical bar allows an operator to hold and pull said circular handle to control the movement of said trolley chassis system.

4. The handle assembly according to claim 3, wherein attachment of handle assembly onto trolley chassis system according to claim 1, comprises of:
a. a pair of long machine screws of predefined length and diameter,
b. a pair of fixed nuts with diameter equal to diameter of long machine screw,
c. said handle assembly is placed behind the front vertical rectangular plank in between the longer bars of said trolley chassis system,
d. wherein a hole is made on either end on the outer surface of said longer bars,
e. whereby said long machine screw enters through the hole on either end of said longer bar to pass through and then enters a hole at the bottom of the small vertical bar of said handle assembly,
f. wherein said long machine screw extends inside to fasten onto said fixed nut,
g. whereby said fixed nut prevents said long machine screw from sliding out off the holes of said handle assembly and said longer bars to securely attach said handle assembly in between said trolley chassis system,
h. wherein the diameter of holes on said longer bar and said handle assembly are larger than the diameter of said long machine screw allowing rotation of said long machine screw one either ends,
i. whereby said handle assembly can be rotated using the circular handle within said trolley chassis system,
j. wherein said handle assembly can rotate to a vertical standing position in parallel to the front vertical rectangular plank during operating condition, or can rotate to a horizontal storage position to rest on top of the flat rectangular planks of said trolley chassis system during non-operating condition.

5. The handle assembly according to claim 3, wherein attachment of handle assembly according to claim 4 onto trolley chassis system according to claim 1, wherein functionality of handle assembly comprises of:
a. a pair of S-shaped hooks of predefined length,
b. two pairs of S-shaped holes of predefined diameter,
c. a S-hook lock mechanism system, wherein diameter of said S-shaped holes ensures said S-shaped hooks can enter to stay fixed and locked within,
d. said S-shaped hook is attached onto the front surface of each small vertical bar of said handle assembly,
e. a pair of S-shaped holes are attached on the ends of front vertical rectangular plank, and a single S-shaped hole is attached onto each said longer bar,
f. whereby when S-shaped hooks of said small vertical bars enter into S-shaped holes of front vertical rectangular plank, S-shaped holes restrict movement of S-shaped hooks to keep said handle assembly in vertical standing position in parallel to front vertical rectangular plank during operating condition,
g. whereby allowing the operator to hold and pull circular handle of said handle assembly, wherein wheels attached at the corners under said trolley chassis system get into motion, whereby allowing operator to control movement and direction of said trolley chassis system during operating condition,
h. wherein during non operating condition, the operator holds onto said circular handle and releases S-shaped hooks of said small vertical bars from S-shaped holes on said front vertical rectangular plank, whereby allowing operator to rotate said handle assembly from vertical standing position to horizontal storage position, wherein said longer vertical bars and said middle support bar of said handle assembly rest on top of said flat rectangular planks,
i. wherein S-shaped hooks on said small vertical bars of said handle assembly are inserted into S-shaped holes of said longer bars, to restrict movement of said S-shaped hooks, in turn restricting rotational movement of said handle assembly, whereby allowing secure storage of said trolley chassis system in horizontal position during non operating condition.

6. The trolley chassis system according to claim 1, wherein handle assembly according to claim 3, wherein said handle assembly set in horizontal storage position according to claim 5, wherein method to store said trolley chassis system in vertical position, comprises of:
a. a support bar stand of predefined length and square cross section,
b. wherein said support bar stand is attached horizontally parallel to the outer edge of one said longer bar using a said long machine screw,
c. wherein diameter of holes on said longer bar and said support bar stand are kept larger than diameter of said long machine screw, whereby allowing rotational movement of said long machine screw and said support bar stand,
d. whereby during non operating condition, operator holds onto said longer bar opposite of said support bar stand to lift said trolley chassis system in vertical position, to allow rotation of said support bar stand,
e. whereby operator turns said support bar stand to a set angle, wherein said set angle is a predefined acute angle (under 90 degrees) measured on the bottom surface in between said support bar stand and said longer bar moving toward the back-side vertical rectangular plank of said trolley chassis system,
f. wherein once said set angle is an acute angle, said support bar stand supports said trolley chassis system in vertical storage position resting onto a floor,
g. whereby allowing postal and parcel workers to store said trolley chassis system in vertical position by the edge of a wall within a work truck, while leaving room in the truck to store mail and packages on their daily routes,
h. whereby vertical storage of said trolley chassis system allows safe storage of said trolley chassis system by the edge of a wall within a work facility to avoid blockages of pathways and hallways.

7. The trolley chassis system according to claim 1, wherein wheel assembly system according to claim 2, wherein handle assembly according to claim 3, wherein attachment of handle assembly according to claim 4, wherein handle assembly functionality mechanism according to claim 5, comprises of:
a. no complex designed machined metal parts,
b. wherein only industry standard metal, wood, screws, nuts, and bolts available at any hardware store are used to build said trolley chassis system,
c. whereby allowing an operator to easily fix problems such as tightening screws using a standard screwdriver on the job to reduce loss of time,
d. whereby an operator can replace broken screws, nuts, or bolts using standard parts available at any hardware store, in turn reducing loss of time due to unexpected service interruption during work hours.
